(19) United States
(12) Patent Application Publication
(10) Pub. No.: US 2016/0364222 A1
(43) Pub. Date: Dec. 15, 2016

(54) METHODS AND SYSTEMS FOR RUNNING MODERN APPLICATIONS IN LEGACY SOFTWARE ENVIRONMENTS

(71) Applicants: Jason C. Schultz, Roseville, MN (US); Robert L. Bergerson, Roseville, MN (US); John A. Peters, Roseville, MN (US)

(72) Inventors: Jason C. Schultz, Roseville, MN (US); Robert L. Bergerson, Roseville, MN (US); John A. Peters, Roseville, MN (US)

(73) Assignee: Unisys Corporation, Blue Bell, PA (US)

(21) Appl. No.: 14/739,255

(22) Filed: Jun. 15, 2015

(51) Int. Cl. G06F 9/445

(52) U.S. Cl. CPC G06F 8/61; G06F 8/54

(57) ABSTRACT

A modern application may be installed, loaded, and run in a legacy software environment by installing a stub library with the application. The stub library can include stub symbolic objects that define functions of external shared libraries called by the application. When the application references external shared libraries that are not already present in the legacy software environment, the stub symbolic objects that define the functions being called from the referenced external shared libraries can be copied into the legacy software environment from the stub library, allowing the application to load and run successfully without the real external shared libraries being installed in the environment.

### FIELD OF THE DISCLOSURE

The instant disclosure relates to software environments. More specifically, this disclosure relates to running modern applications in legacy software environments.

### BACKGROUND

When an application is built and run in a Linux software environment, it is first compiled and then linked. The build process may create a file with a file name ending in .so, meaning that the application was built as a shared library, and the resulting file is a shared library. This shared application can be dynamically linked to and call functions from other shared libraries. If the application dynamically links to external shared libraries, the external references to those libraries need to be resolved at load time.

When an application attempts dynamic linking at load time, it needs to find the referenced external shared libraries in the software environment, and resolve the external referenced function entry points that are called by the application. If the application is unable to do so, it will error, and will not load. This is the case when implementing, on legacy systems, new features that require the application to use new external libraries present on modern systems, such as System Architecture Interface Layer (SAIL) based systems. The problem exists in other systems as well and therefore is not limited to SAIL-based or Linux-based systems.

When an application starts up, it is scanned for references to functions defined by external shared libraries. If those referenced external libraries are located in the software environment, the application can locate the external shared libraries and resolve function entry points. However, if the application is installed in a legacy software environment, the legacy environment may not have all referenced external shared libraries installed. If this happens, the references to any external shared libraries not located in the software environment cannot be found and resolved, and the application will not run successfully.

### SUMMARY

A modern application that references external shared libraries that are not installed in a legacy software environment may be installed in the legacy software environment by installing a stub library with the application. The stub library may contain stub symbolic objects that define the functions of the external shared libraries that are called by the application. The stub symbolic objects can be copied from the stub library into the legacy software environment, allowing the application to load and run successfully.

According to one embodiment, a method may include installing, by a processor, an application and a stub library in a software environment. The method may also include scanning, by the processor, the application to identify one or more references to external shared libraries. The method may further include identifying, by the processor, one or more referenced external shared libraries not present in the software environment. The method may also include copying, by the processor, a stub symbolic object from the stub library to the software environment for each of the identified one or more external shared libraries not present in the software environment. The method may further include linking, by the processor, referenced external shared libraries present in the software environment to the application, and linking, by the processor, stub symbolic objects copied to the software environment to the application.

According to another embodiment, a computer program product may include a non-transitory computer readable medium comprising instructions which, when executed by a processor of a computing system, cause the processor to perform the step of installing an application and a stub library in a software environment. The medium may also include instructions which, when executed by the processor, cause the processor to perform the steps of scanning the application to identify one or more references to external shared libraries and identifying one or more referenced external shared libraries not present in the software environment. The medium may further include instructions which, when executed by the processor, cause the processor to perform the steps of copying a stub symbolic object from the stub library to the software environment for each of the identified one or more external shared libraries not present in the software environment, linking referenced external shared libraries present in the software environment to the application, and linking stub symbolic objects copied to the software environment to the application.

According to a further embodiment, an apparatus may include a memory, and a processor coupled to the memory. The processor may be configured to execute the steps of installing an application and a stub library in a software environment, scanning the application to identify one or more references to external shared libraries, and identifying one or more referenced external shared libraries not present in the software environment. The processor may also be configured to execute the steps of copying a stub symbolic object from the stub library to the software environment for each of the identified one or more external shared libraries not present in the software environment, linking referenced external shared libraries present in the software environment to the application, and linking stub symbolic objects copied to the software environment to the application.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is flow chart illustrating a method for installing an application with a stub library according to one embodiment of the disclosure.

FIG. 2 is a block diagram illustrating an application executed within a software environment according to one embodiment of the invention.

FIG. 3 is a flow chart illustrating the process of creating a stub symbolic object for an external shared library referenced by an application, according to one embodiment of the disclosure.

FIG. 4 is a flow chart illustrating an RPM Package Manager (RPM) install process for an application with a stub library, according to one embodiment of the disclosure.

FIG. 5 is a block diagram illustrating a computer system for implementing embodiments of the disclosure according to one embodiment of the disclosure,

### DETAILED DESCRIPTION

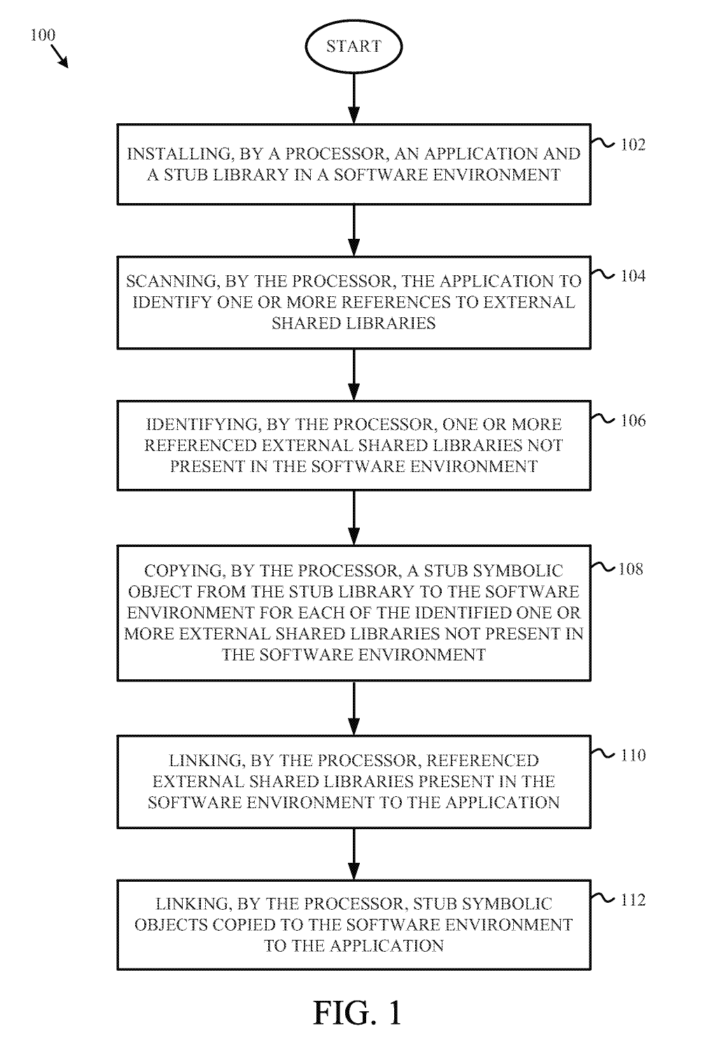

FIG. 1 is a flow chart illustrating a method for installing an application with a stub library according to one embodiment of the disclosure. A method 100 may start at block 102 by installing, by a processor, an application and a stub library in a software environment. In some embodiments, the application and the still) library may be included in an RPM file. The software environment may be a legacy software environment, and the application may be a modern Linux application. Therefore, the software environment may be a software environment different from the software environment in which the application was originally built. At Hock 104, the method may include scanning, by the processor, the application to identify one or more references to external shared libraries. References may be to external shared libraries already installed in the software environment, or to external shared libraries that have not been installed in the software environment. Therefore, at block 106, method 100 may include identifying, by the processor, one or more referenced external shared libraries not present in the software environment.

At block 108, the method may include copying, by the processor, a stub symbolic object from the stub library to the software environment for each of the identified one or more external shared libraries not present in the software environment. The stub library may be a “fake” library, with stub symbolic objects that contain the external entry points for the functions of the external shared libraries that the application requires, but without having the functionality of the real external libraries. Therefore, a stub library may include one or more stub symbolic objects. The stub symbolic objects may be copied to the locations expected by the application in the software environment. A shell script may be invoked to copy the stub symbolic objects to the software environment. The stub symbolic objects may define functions of the referenced external shared libraries called by the application.

At block 110, the method may include linking, by the processor, referenced external shared libraries present in the software environment to the application. Because these external shared libraries are present in the software environment, they may be located and their function entry points may be resolved. Thus, dynamic linking to these external shared libraries will succeed. At block 112, the method may include linking, by the processor, stub symbolic objects copied to the software environment to the application. Even though the stub symbolic objects are not the real external shared libraries called by the application, the application can resolve the external entry points for the functions of the external shared libraries called by the application by dynamically linking to the stub symbolic objects.

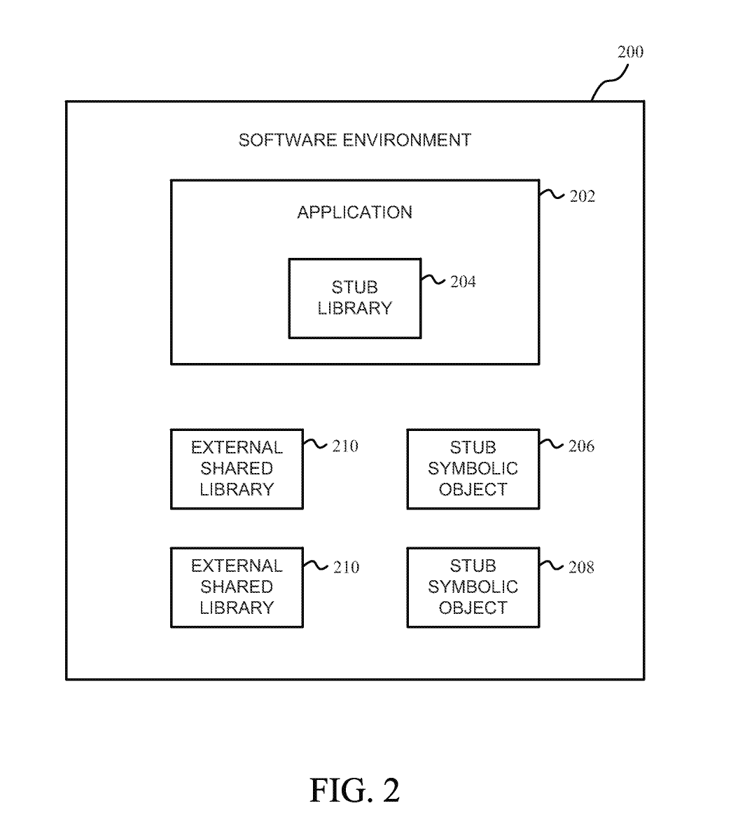

FIG. 2 illustrates an application 202 to be executed within a software environment 200 according to one embodiment of the invention. The software environment 200 may be a legacy software environment, such as a Mariner 3 system. The installed application 202 may be a modern application, such as an extended network input output processor (XNIOP) that is built with and targeted for release on a modern software environment, such as a Mariner 4 system. A stub library 204 may be included with the application 202.

From the stub library 204, stub symbolic objects 206, 208 may be copied into the software environment 200. For example, a stub symbolic object 206 that defines the functions called by the application 202 from a first external shared library may be copied to the location in the software environment 200 expected by the application 202. A stub symbolic object 208 that defines the functions called by the application 202 from a second external shared library may be copied to the location in the software environment 200 expected by the application 202. The application 202 may dynamically link to the stub symbolic objects 206, 208. There also may be real external shared libraries 210 installed in the software environment 200. The application 202 may dynamically link to the external shared libraries 210.

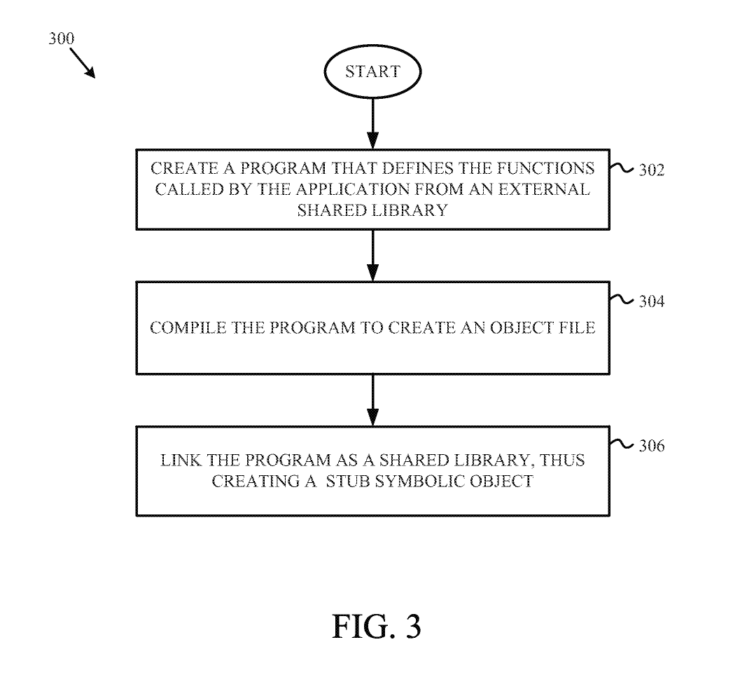

FIG. 3 is a flow chart illustrating the process of creating a stub symbolic object for an external shared library referenced by an application, according to one embodiment of the disclosure. The process 300 may begin at block 302 with creating a program, such as a C program, that defines the functions called by the application from an external shared library. These functions defined in the C program may be essentially empty, as the functions may only need to match the function definitions in the real external shared library by having the same parameters and returning the same type of value. At block 304, the process may include compiling the program to create an object file. At block 306, the process may include linking the program as a shared library, thus creating a stub symbolic object. The SONAME of this stub symbolic object may be set to have the same SONAME as the real external shared library.

For example, in one embodiment, the shared library application ourapp.so may make calls to functions shared_lib_func1 and shared_lib_func2, which are both defined by the real external library sharedlibx.so. At block 302, a C program, oursymobj.c, may be created, defining the two functions, shared_lib func1 and shared_lib_func22. At block 304, the oursymobj.c program may be compiled to create an object file, oursymobj.o. Then, at block 306, the object file may be linked as a shared library, creating a stub symbolic object, oursymobj.so. The SONAME of this stub symbolic object may be set to sharedlibx.so, the same SONAME of the real external library. Copying this stub symbolic object from a stub library included with the application to the software environment will allow the application to load and run in the software environment without the real external library being present in the software environment.

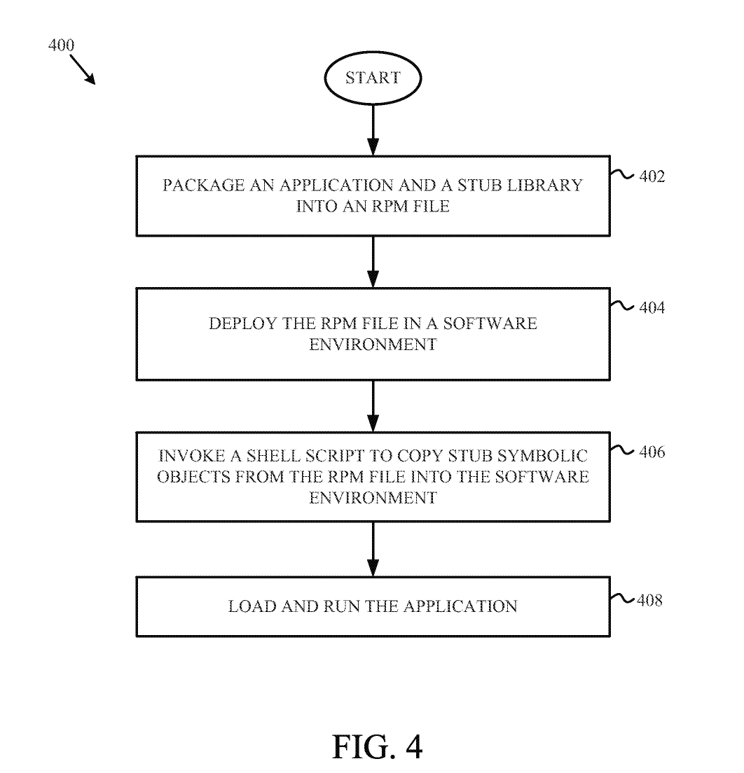

FIG. 4 illustrates an RPM install process for an application with a stub library, according to one embodiment of the disclosure. The RPM install 400 may begin at block 402 with packaging an application and a stub library into an RPM file. At block 404, the RPM install may include deploying the RPM file in a software environment. At block 406, the RPM install may also include invoking a shell script to copy one or more stub symbolic objects from the RPM file into the software environment. This may include copying the stub symbolic objects to the software environment in the locations and with the names expected by the application. At block 408, the RPM install may include loading and running the application. Loading the application may include resolving the external references to functions of the external shared libraries called by the application.

For example, in one embodiment, at block 402, the application ourapp.so may be packaged with the stub library oursymobj.so into an RPM file. The application ourapp.so may call to functions shared_lib_func1 and shared_lib_func2, which are both defined by the external shared library sharedlibx.so. At block 404, the packaged RPM file may be deployed into the software environment. A block 406, a shell script may be invoked to copy from the stub library a stub symbolic object, oursymobj.so, which defines functions shared_lib_func1 and shared_lib_func2. The stub symbolic object may be copied to the location in the software environment expected by the application ourapp.so. For example, the location may be /usr/lib64/. The SONAME of the copied stub symbolic object oursymobj.so may be sharedlibx.so, the same SONAME of the real external library. After these steps, at block 408, ourapp.so can load and run successfully. For example, the ourapp.so file will indicate that a symbolic object called sharedlibx.so is required. This file can be found by ourapp.so in /usr/lib64/, because the script invoked by the RPM install at block 406 copied the stub symbolic object oursymobj.so with the SONAME sharedlibx.so to that location. The ourapp.so file can resolve its external references to the shared_lib_func1 and shared_lib_func0 functions by the stub symbolic object oursymobj.so, which defines these functions.

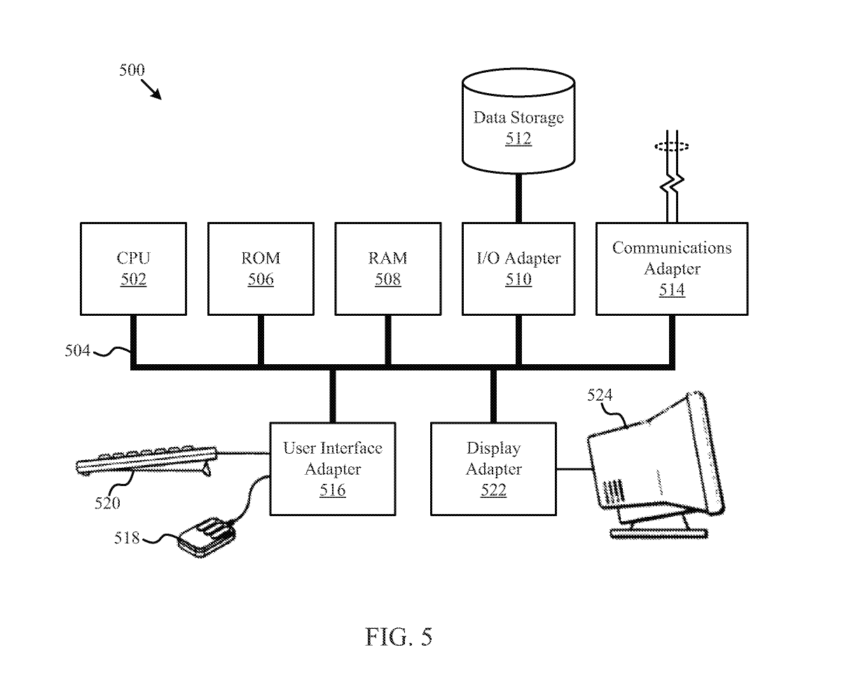

FIG. 5 illustrates a computer system 500 adapted according to certain embodiments of a server and/or a user interface device for implementing embodiments of the disclosure. For example, computer system 500 may implement each of the embodiments illustrated in FIGS. 1-4. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations described herein. The CPU 502 may execute the various logical instructions according to the present embodiments.

The computer system 500 may also include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (RUM) 506 which may be PROM, EPROM, EEPROM, optical storage, or the like. The ROM may store configuration information for booting the computer system 500. The RAM 508 and the ROM 506 hold user and system data and both the RAM 508 and the ROM 506 may be randomly accessed.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to a network, which may be one or more of a LAN, WAN, and/or the Internet. The user interface adapter 516 couples user input devices, such as a keyboard 520, a pointing device 518, and/or a touch screen (not shown) to the computer system 500. The display adapter 522 may be driven by the CPU 502 to control the display on the display device 524. Any of the devices 502-522 may be physical and/or logical.

The applications of the present disclosure are not limited to the architecture of computer system 500. Rather the computer system 500 is provided as an example of one type of computing device that may be adapted to perform the functions of a server and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, in some embodiments, aspects of the computer system 500 may be virtualized for access by multiple users and/or applications.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform. substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
installing, by a processor, an application and a stub library in a software environment;
scanning, by the processor, the application to identify one or more references to external shared libraries;
identifying, by the processor, one or more referenced external shared libraries not present in the software environment;
copying, by the processor, a stub symbolic object from the stub library to the software environment for each of the identified one or more external shared libraries not present in the software environment;
linking, by the processor, referenced external shared libraries present in the software environment to the application; and
linking, by the processor, stub symbolic objects copied to the software environment to the application.

2. The method of claim 1, in which a stub library includes one or more stub symbolic objects.

3. The method of claim 1, in which the application and the stub library are included in an RPM Package Manager (RPM) file.

4. The method of claim 1, in which the software environment is a software environment different from the software environment in which the application was originally built.

5. The method of claim 1, in which each stub symbolic object s copied to a location in the software environment that is expected by the application.

6. The method of claim 1, in which each stub symbolic object defines at least one external function called by the application.

7. The method of claim 1, wherein the step of copying comprises invoking a shell script,

8. A computer program product, comprising:
a non-transitory computer-readable medium comprising, instructions which, when executed by a processor of a computing system, cause the processor to perform the steps of:
installing an application and a stub library in a software environment;
scanning the application to identify one or more references to external shared libraries;
identifying one or more referenced external shared libraries not present in the software environment;
copying a stub symbolic object from the stub library to the software environment for each of the identified one or more external shared libraries not present in the software environment;
linking referenced external shared libraries present in the software environment to the application; and
linking stub symbolic objects copied to the software environment to the application.

9. The computer program product of claim 8, in which a stub library includes one or more stub symbolic objects.

10. The computer program product of claim 8, in which the application and the stub library are included in an RPM Package Manager (RPM) file,

11. The computer program product of claim 8, in which the software environment is a software environment different from the software environment in which the application was originally built.

12. The computer program product of claim 8, in which each stub symbolic object is copied to a location in the software environment that is expected by the application.

13. The computer program product of claim 8, in which each stub symbolic object defines at least one external function called by the application.

14. The computer program product of claim 8, wherein the step of copying comprises invoking a shell script,

15. An apparatus, comprising:
a memory; and
a processor coupled to the memory, the processor configured to execute the steps of
installing an application and stub library in a software environment;
scanning the application to identify one or more references to external shared libraries;
identifying one or more referenced external shared libraries not present in the software environment;
copying a stub symbolic object from the stub library to the software environment for each of the identified one or more external shared libraries not present in the software environment;
linking referenced external shared libraries present in the software environment to the application; and
linking stub symbolic objects copied to the software environment to the application.

16. The apparatus of claim 15, in which a stub library includes one or more stub symbolic objects.

17. The apparatus of claim 15, in which the application and the stub library are included in an RPM Package Manager (RPM) file.

18. The apparatus of claim 15, in which the software environment is a software environment different from the software environment in which the application was originally built.

19. The apparatus of claim 15, in which each stub symbolic object is copied to a location in the software environment that is expected by the application.

20. The apparatus of claim 15, in which each stub symbolic object defines at least one external function called by the application,
